(19) United States
(12) Patent Application Publication
(10) Pub. No.: US 2026/0296760 A1
(43) Pub. Date: Oct. 1, 2026

(54) IMPROVED HOP FLAVOUR IN CANNED BEER

(71) Applicant: Heineken Supply Chain B.V., Amsterdam (NL)

(72) Inventors: Jeremy Daniel MARSHALL, Bodega Bay, CA (US); Bryan Robert DONALDSON, Santa Rosa, CA (US); Allard DE GROOT, Alphen aan den Rijn (NL)

(21) Appl. No.: 19/136,570

(22) PCT Filed: Dec. 11, 2023
(86) PCT No.: PCT/NL2023/050651

§ 371 Date: Jun. 6, 2025

Related U.S. Application Data
(60) Provisional application No. 63/431,379, filed on Dec. 9, 2022.

(30) Foreign Application Priority Data
Dec. 19, 2022 (EP) 22214724.1

(51) Int. Cl. B65D 81/32; B65D 17/28; B65D 85/72; C12C 5/02

(52) U.S. Cl. CPC B65D 81/3238; B65D 17/4012; B65D 85/72; C12C 5/026; B65D 2517/0011; B65D 2517/0056

(57) ABSTRACT

Improved hop flavour in canned beer Beverage can (100), comprising: a can body (102) with a primary volume (103) partially filled with a beer (107); a secondary compartment (202) positioned inside the primary volume and defining a secondary volume, the secondary volume being at least partially filled with hop compounds (204), and comprising a separator (206) separating the secondary volume from the beer; a lid (104) sealing a top opening of the can body; an opening mechanism (106) for opening an opening (108) in the lid, wherein the opening mechanism is arranged to, when actuated by a user: open the opening in the lid such that the beer can be poured through said opening; break the separator such that the hop compounds in the secondary volume are exposed to the beer in the primary volume.

### TECHNICAL FIELD

The aspects and embodiments thereof relate to field of canned beer.

### BACKGROUND

Beer is typically brewed using hops, which are the flowers of the hop plant Humulus lupulus. The hops are commonly used as a flavouring agent to add bitter, floral, fruity, and/or citrussy notes to the beer.

It is known that the hop flavour in beer diminishes over time. This is particular observed in beers of a beer style which has a hoppy flavour profile and/or hoppy aroma profile, such as India Pale Ales (IPA). As such, consumers now have to consume these beers within a short timespan after the beer has been produced.

In order to increase hop flavour in beer, for example dry hopping is used. This hopping technique involves adding hops late in the brewing process, for example in the fermentation tanks, after the wort has been cooled down.

### SUMMARY

It is an object of the present disclosure to provide beer to consumers with an increase shelf life, while maintaining a desired level of hop flavour in the beer. The desired level of hop flavour may be similar to or even higher than the level of hop flavour present in the beer just after brewing. In particular, the present disclosure concerns shelf life of canned beer.

The level of hop flavour may be expressed on the International Bitterness Units (IBU) scale, where beers with a hoppy flavour profile and/or hoppy aroma profile typically have a IBU level between 30-120. 1 IBU equals to 1 mg/l or 1 ppm of iso-alpha acids in the beer.

To provide consumers with beer with an improved level of hop flavour compared to beer in known beverage cans, the present disclosure in a first aspect provides a beverage can, comprising a can body with a primary volume at least partially filled with a beer. The beverage can further comprises a secondary compartment positioned inside the primary volume and defining a secondary volume, the secondary volume being at least partially filled with hop compounds. The secondary compartment comprises a separator separating the secondary volume from the beer. The beverage can further comprises a lid, sealing a top opening of the can body, and an opening mechanism for opening an opening in the lid.

The opening mechanism is arranged to, when actuated by a user, open the opening in the lid such that the beer can be poured through said opening, and break the separator such that the hop compounds in the secondary volume are exposed to the beer in the primary volume. Preferably, the hop compounds are allowed to fall into the beer after actuation of the opening mechanism by virtue of gravity.

By keeping the hop compounds separated from the beer during transport and storage of the beverage can, deterioration of the hop flavours of the hop compounds may be reduced compared to a situation wherein the hop compounds would have been added to the beer prior to transport and storage. It will be appreciated that the beer in the beverage can may be essentially free of hop compounds, or conceivably can also comprise hop compounds.

Providing the beer and the hop compounds in a single beverage can may be convenient to the consumer, as it requires purchase, transport, and storage of a single item-compared to having to purchase, transport, and store beer and hop compounds separately. Furthermore, by providing the beer and the hop compounds in a single beverage can, it may be ensured that the correct ratio of beverage and hop compounds is obtained, and the consumer is not burdened with dosing the correct amount of hop compounds for the volume of beer present in the beverage can.

Hops typically comprise chemical compounds such as alpha acids, such as humulones (α-lupulic acids), iso-alpha acids, such as isohumulones, beta acids, such as lupulones, essentials oils, and flavonoids such as xanthohumol. These hop compounds may be of natural origin—i.e. from actual hop plants, in particular from flowers of the hop plant Humulus lupulus—or conceivably may be synthesised.

Because the hop compounds are now kept separate from the beer, the hop compounds may be provided as solid particles compared to conventional beers where all of the hop compounds are dissolved in the beer, also during transport and storage of the beverage can in which the beer is stored.

Preferably, but not necessarily, the hop compounds are provided as a granular material. Such a granular material comprises discrete particles, which may be counted. Typically, the discrete particles remain discrete particles while present in the secondary compartment. A powder is also understood to be a granular material, with particles with a particularly small particle size. For example, the hop compounds may be provided as encapsulated hop oils. Additionally or alternatively, the hop compounds may be provided in liquid form. Hop compounds in liquid form may dissolve more easily in the beer.

When the hop compounds are provided as discrete particles, it may occur that not all particles fall into the beer directly when the separator is broken. For example, one or more particles may remain trapped in the secondary volume also while the beer is poured from the opening of the can body. One or more particles may for example remain trapped behind the separator.

When one or more particles remain trapped until the beverage can is completely emptied, the desired amount of hop flavours in the beer is not achieved. However, with an increased number of particles, the effect of one or more particles remaining trapped is lower compared to a situation wherein the hop compounds are provided by a lower number of particles. For example, when one of only two particles remains trapped, the desired amount of added hop flavours is halved. If one of a total of ten particles remains trapped, the desired amount of added hop flavours is only decreased by 10%.

Additionally or alternatively, when or more particles are trapped in the secondary compartment and are only released into the beer after some of the beer has already been poured from the beverage can, the level of hop flavour in the remaining beer may become too high.

To decrease the effect that a single particle has on the total hop flavour level of the beer, it may be preferred that more than ten particles, more than twenty particles, more than fifty particles, or even more than 100 particles are present in the secondary compartment. In any combination, the hop compounds may also be provided as at most 100 particles, at most fifty particles, or even at most twenty particles.

It will be appreciated that in any embodiment of the beverage can disclosed herein, next to hop compounds, also other compounds can be present in the secondary volume. These other compounds may for example be used to dilute the hop compounds such that the same amount of hop compounds can be divided over a larger number of discrete particles.

In any embodiment of any beverage can disclosed herein in the secondary compartment at least 5 milligrams of hop compounds per mL of beer in the primary volume may be present, or even at least 10 milligrams of hop compounds per mL of beer in the primary volume.

A can, also referred to as drink can or beverage can, is a beverage container arranged to hold a particular volume of beverage, such as 300 ml, 330 ml, 500 ml, or any other volume. Typically, a can is made from a metal such as aluminium or tin-plated steel. Modern cans comprise a can body, and a lid which is typically connected to the can body using a roll seam. In the lid, a weakened section is provided which can be opened by a user action. Typically, the lid is provided with a pull tab as an opening mechanism, which upon actuation by the user severs the weakened section, thereby creating an opening in the lid through which the beverage can be dispensed, poured, or directly drunk.

In the primary volume of the beverage can, beer, the secondary compartment, and optionally a headspace may be present. In normal use, i.e. with the lid facing upwards, the secondary compartment may be positioned in the headspace.

The lid may comprise a weakened section partially surrounding a hatch portion of the lid. When the lid comprises a weakened section partially surrounding the hatch portion, the opening mechanism may comprise a pull tab arranged to rupture the weakened section when actuated by a user, and to move the hatch portion in a hinging movement into the primary volume. The hatch portion may remain connected to the lid via a living hinge.

In particular, the hatch portion may be arranged to, upon user actuation of the opening mechanism, break the separator such that the hop compounds in the secondary volume are exposed to the beer in the primary volume.

The secondary compartment may be at least partially positioned below the hatch portion of the lid. Additionally, or alternatively, the secondary compartment may be connected to the lid. This may facilitate convenient assembly of the beverage can, preferably using conventional roll seam equipment for connecting the lid to the can body. When the secondary compartment is connected to the lid, the secondary compartment may be separate from the can body—i.e. not directly connected to the can body.

Generally, the secondary volume may be defined between the secondary compartment and at least part of the lid, in particular a bottom side of the lid facing towards the primary volume. Alternatively, the secondary volume may be defined between the secondary compartment, at least part of the lid, and at least part of the can body. As an even further alternative, the secondary volume may be defined between the secondary compartment, and at least part of the can body.

The separator separating the secondary volume from the beer may comprise or consist of a thin foil, for example a thin sheet made from food-grade material, such as aluminium. When the opening mechanism is used to break the separator, the thin foil may for example be ruptured or ripped open. In general, when the separator breaks the hop compounds may fall into the beer by virtue of gravity.

Generally, the opening mechanism is arranged to irreversibly open the opening when actuated by the user. In other words, the opening mechanism cannot be used to close or seal the opening after being opened.

A second aspect of the present disclosure provides a method of forming a beverage can. The beverage can formed using the method can provide a beer with an increase hop flavour to a consumer. The method comprises steps of:

providing a can body with a primary volume and an opening into the primary volume;

filling the primary volume of the can body with a beer;

positioning a secondary compartment defining a secondary volume at least partially filled with hop compounds in the primary volume;

providing a separator separating the secondary volume from the beer; and

sealing the opening into the primary volume with a sealing member, such as a lid or cap.

The steps in the method may be performed in any order. Optionally, one or more steps may be performed simultaneously.

The sealing member, the secondary compartment, and the separator may be connected prior to the step of sealing the opening into the primary volume. As such, when the opening into the primary volume is sealed using the sealing member, the secondary compartment with the separator is conveniently positioned into the primary volume.

### BRIEF DESCRIPTION OF THE FIGURES

In the figures,

FIGS. 1A and 1B schematically depict a top section of a beverage can; and

FIG. 2 shows a beverage can in an isometric view.

### DETAILED DESCRIPTION OF THE FIGURES

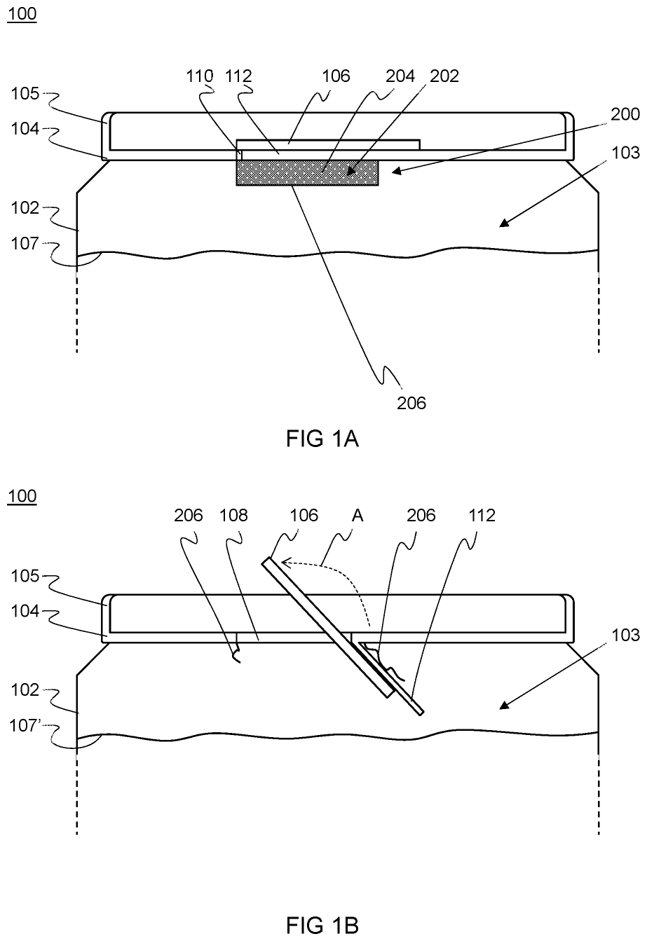

FIGS. 1A and 1B schematically depict a top section of a beverage can 100 in a section view. The beverage can 100 comprises a can body 102, part of which is depicted in FIGS. 1A and 1B. The can body 102 can be a cylindrical body. The can body 102 defines a primary volume 103 which is partially filled with a beer 107. The can 100 further comprises a lid 104 connected to the can body 102 and liquid-tightly sealing the primary volume 103. A headspace 105 may be present between the beer 106 and the lid 104. Optionally, the lid 104 may comprise an upward protruding rim 105.

The can 100 comprises a pull tab 106 as an opening mechanism, arranged to-when operated by a user—open up an opening 108 in the lid. FIG. 1A shows the can 100 is a situation prior to user actuation of the opening mechanism 106, and FIG. 1B shows the can 100 after user actuation of the opening mechanism 106. Dashed arrow A generally indicates a pivoting motion made by the pull tab 106 due to the user actuation.

The beverage can 100 comprises a secondary compartment 200 which is positioned inside the primary volume 103—and thus inside the can 100. Inside the secondary compartment 200, a secondary volume 202 is defined which is filled with hop compounds 204. The hop compounds 204 can for example be in a solid form, for example as a granular material, for example as a powder or discrete granules.

In the embodiment of the beverage can 100 depicted in FIGS. 1A and 1B, a thin foil 206 is used as a separator separating the secondary volume 202 from the beer 107. The thin foil 206 is arranged to ripped open when the pull tab 106 is operated by the user.

As can be seen in FIG. 1B, the thin foil 206 is ripped open when the pull tab 106 is operated, because the pull tab 106 opens a hatch portion 112 of the lid. The hatch portion 112 is typically surrounded by a weakened section 110 to aid the user in breaking the hatch portion 112 away from the rest of the lid 104. Because the hatch portion 112 is moved in a hinging movement into the primary volume 103, the opening 108 is opened in the lid 104 to allow beer 107 to be poured from the can 100.

After the foil 206 has been ripped open, the hop compounds 204 can fall into the beer 107. The beer 107 then turns into a beer 107′ with an improved hop flavour by virtue of the hop compounds 204 mixing with the beer. For example when the hop compounds 204 are provided in a solid form, the hop compounds 204 can dissolve in the liquid beer.

As shown in FIG. 1A, the secondary compartment 200 can be at least partially positioned below the hatch portion 112. This allows a conventional hatch portion 112 to be used to break the thin foil 206. Such a conventional hatch portion 112 preferably has a substantially smooth lower surface facing the primary volume 103. Being substantially smooth implies that the lower surface is for example free of protrusions, in particular sharp protrusions.

As an option further shown in FIG. 1A, the secondary compartment 200 is connected to the lid 104, and particularly not directly connected to the can body 102.

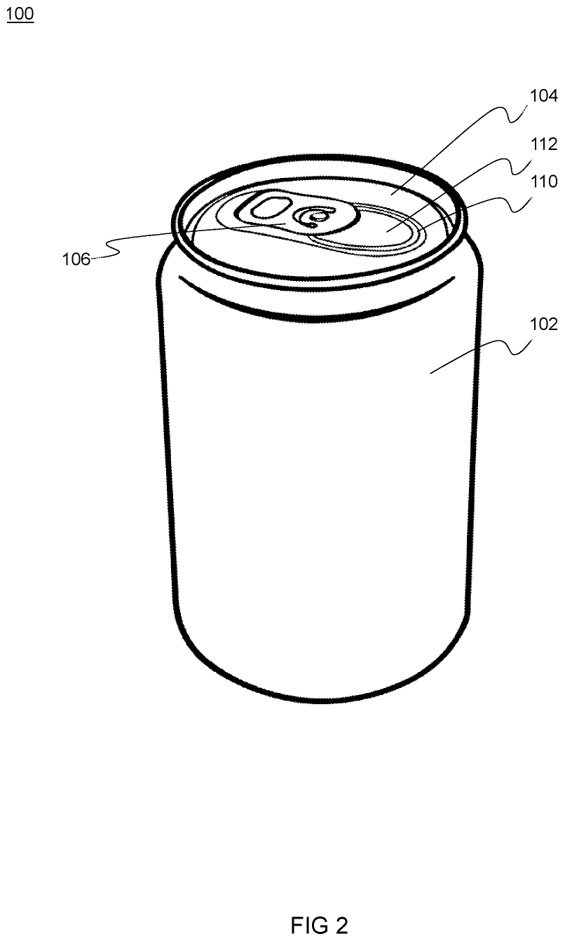

FIG. 2 shows an example of a beverage can 100 as an example of the present disclosure. The can 100 comprises the can body 102, with the lid 104 connected to the can body 102. The lid 104 comprises the weakened section 110 partially surrounding the hatch portion 112 of the lid. A pull tab 106 is provided as an opening mechanism for opening an opening in the lid such that the beer can be poured through said opening and breaking a separator of a secondary compartment positioned inside the beverage can such that hop compounds in the secondary volume are exposed to the beer in the primary volume.

As can be seen in FIG. 2, from the outside, the secondary compartment is not visible to the user as it is surrounded by the can body 102 and the lid 104. Furthermore, because the secondary compartment is positioned in the primary volume, the separator is protected from outside influences by the can body. Outside influences such as impacts may otherwise inadvertently break the separator, thereby exposing the hop compounds in the secondary volume to early—i.e. before the can is opened and the consumer intends to consume the beer.

In the description above, it will be understood that when an element is referred to as being connect to another element, the element is either directly connected to the other element, or intervening elements may also be present. Also, it will be understood that the values given in the description above, are given by way of example and that other values may be possible and/or may be strived for.

It is to be noted that the figures are only schematic representations of embodiments that are given by way of non-limiting examples. For the purpose of clarity and a concise description, features are described herein as part of the same or separate embodiments, however, it will be appreciated that the scope of the disclosure may include embodiments having combinations of all or some of the features described.

1. A beverage can, comprising:
a can body with a primary volume partially filled with a beer;
a secondary compartment positioned inside the primary volume and defining a secondary volume, the secondary volume being at least partially filled with hop compounds, and comprising a separator separating the secondary volume from the beer;
a lid sealing a top opening of the can body;
an opening mechanism for opening an opening in the lid,
wherein the opening mechanism is arranged to, when actuated by a user:
open the opening in the lid such that the beer can be poured through said opening; and
break the separator such that the hop compounds in the secondary volume are exposed to the beer in the primary volume.

2. The beverage can according to claim 1, wherein the hop compounds are provided as particles of a granular material.

3. The beverage can according to claim 2, wherein the secondary volume if is filled with at least ten particles,

4. The beverage can according to claim 1, wherein the hop compounds are provided in liquid form.

5. The beverage can according to claim 1, wherein the lid comprises a weakened section partially surrounding a hatch portion of the lid, and the opening mechanism comprises a pull tab arranged to rupture the weakened section when actuated by a user, and to move the hatch portion in a hinging movement into the primary volume.

6. The beverage can according to claim 5, wherein the hatch portion of the lid is arranged to, upon user actuation of the opening mechanism, break the separator such that the hop compounds in the secondary volume are exposed to the beer in the primary volume.

7. The beverage can according to claim 1, wherein the secondary compartment is connected to the lid.

8. The beverage can according claim 1, wherein the secondary volume is defined between the secondary compartment and at least part of the lid.

9. The beverage can according to claim 1, wherein the separator comprises a thin foil.

10. The beverage can according to claim 1, wherein the secondary volume comprises at least 5 milligrams of hop compounds per litre of beer in the primary volume.

11. The beverage can according to claim 1, wherein the opening mechanism is arranged to irreversibly open the opening when actuated by the user.

12. The beverage can according to claim 1, wherein the hop compounds in the secondary compartment directly contact the lid or cap.

13. The beverage can according to claim 5, wherein the hatch portion has a substantially smooth lower surface facing the primary volume.

14. A method of forming a beverage can, comprising steps of:
providing a can body with a primary volume and an opening into the primary volume;
filling the primary volume of the can body with a beer;
positioning a secondary compartment defining a secondary volume at least partially filled with hop compounds in the primary volume;
providing a separator separating the secondary volume from the beer; and
sealing the opening into the primary volume with a sealing member, such as a lid or cap.

15. The method according to claim 14, wherein the sealing member, the secondary compartment, and the separator are connected prior to the step of sealing the opening into the primary volume.

16. The beverage can according to claim 3, wherein the secondary volume is filled with at least 20 particles.

17. The beverage can according to claim 5, wherein the secondary compartment is at least partially positioned below the hatch portion of the lid.
